(19) United States
(12) Patent Application Publication
(10) Pub. No.: US 2014/0040152 A1
(43) Pub. Date: Feb. 6, 2014

(54) METHODS AND SYSTEMS FOR FAKE ACCOUNT DETECTION BY CLUSTERING

(71) Applicants: Jing Fang, Vancouver (CA); Christopher Stein, San Francisco, CA (US); Wanhong Xu, Menlo Park, CA (US)

(72) Inventors: Jing Fang, Vancouver (CA); Christopher Stein, San Francisco, CA (US); Wanhong Xu, Menlo Park, CA (US)

(21) Appl. No.: 13/565,628

(22) Filed: Aug. 2, 2012

(51) Int. Cl. G06Q 99/00

(52) U.S. Cl. 705/319

(57) ABSTRACT

Techniques to determine fake accounts of a social networking system. In one embodiment, a magnitude of a cluster of accounts is calculated. The social networking system determines the accounts are fake when the magnitude of the cluster is less than a threshold value. The accounts are not determined to be fake, or determined to be not fake, when the magnitude of the cluster is equal to or greater than the threshold value. The accounts may be associated with at least one resource. A mapping of the accounts may be created based on features associated with the accounts. A radius of the cluster is compared with the threshold value. The accounts are determined to be fake when the radius is less than the threshold value.

### FIELD OF THE INVENTION

The present application relates to account management in a social networking system and, in particular, detection of fake accounts in a social networking system.

### BACKGROUND

Social networking websites provide a dynamic environment in which members can connect to and communicate with other members. These websites may commonly provide online mechanisms allowing members to interact within their preexisting social networks, as well as create new social networks. Members may include any individual or entity, such as an organization or business. Among other attributes, social networking websites allow members to effectively and efficiently communicate relevant information to their social networks.

A member of a social network may highlight or share personal information, news stories, relationship activities, music, and any other content of interest to areas of the website dedicated to the member. Other members of the social network may access the shared content by browsing member profiles or performing dedicated searches. Upon access to and consideration of the content, the other members may react by taking one or more responsive actions, such as providing an opinion about the content, or other feedback. The ability of members to interact in this manner fosters communications among them and helps to realize the goals of social networking websites.

The integrity and usefulness of a social networking website depends on genuine participation by its true members. Illegitimate entities who create fake accounts with the social network may detract from the purposes and spirit of a social network. Fake accounts can be used to serve improper purposes, such as spamming members of the social network with irrelevant, endless, or otherwise inappropriate communications. Thus, the management of fake accounts is important to protect the social network and its underlying purposes. The identification and elimination of fake accounts helps to preserve the full potential of the social network as a powerful medium for the active exchange of invited, relevant content.

### SUMMARY

To identify fake accounts in a social networking system, embodiments of the invention include systems, methods, and computer readable media to calculate a magnitude of a cluster of accounts. The social networking system determines the accounts are fake when the magnitude of the cluster is less than a threshold value. The accounts are not determined to be fake, or determined to be not fake, when the magnitude of the cluster is equal to or greater than the threshold value.

In an embodiment, at least one resource is identified. The at least one resource may include a scarce resource. Accounts associated with the at least one resource may be identified.

In an embodiment, a mapping of the accounts may be created based on features associated with the accounts. The mapping of the accounts may be based on values of the features associated with the accounts. The features may be associated with a dimension of the social networking system including at least one of activities and users.

In an embodiment, a centroid of the cluster is determined. A furthest point representing an account from a centroid of the cluster is determined. A distance between the centroid and a point representing each of the accounts is calculated. A radius of the cluster may be determined.

In an embodiment, the radius is compared with the threshold value. The accounts are determined to be fake when the radius is less than the threshold value. The accounts are not determined to be fake, or are determined to be not fake, when the radius is equal to or greater than the threshold value.

In an embodiment, the threshold value may be programmable.

Many other features and embodiments of the invention will be apparent from the accompanying drawings and from the following detailed description.

### BRIEF DESCRIPTION OF THE DRAWINGS

FIG. 1 is a network diagram of a system for fake account detection within a social networking system in accordance with an embodiment of the invention.

FIGS. 2A-2B illustrate a cluster of accounts determined to be fake in accordance with an embodiment of the invention.

FIGS. 3A-3B illustrate a cluster of accounts not determined to be fake in accordance with an embodiment of the invention.

FIG. 4 is process for determining that accounts are fake in accordance with an embodiment of the invention.

FIG. 5 is a process for comparing a cluster magnitude with a threshold value to determine if accounts are fake in accordance with an embodiment of the invention.

FIG. 6 shows a diagram of a computer system in accordance with an embodiment of the invention.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

### Social Networking System—General Introduction

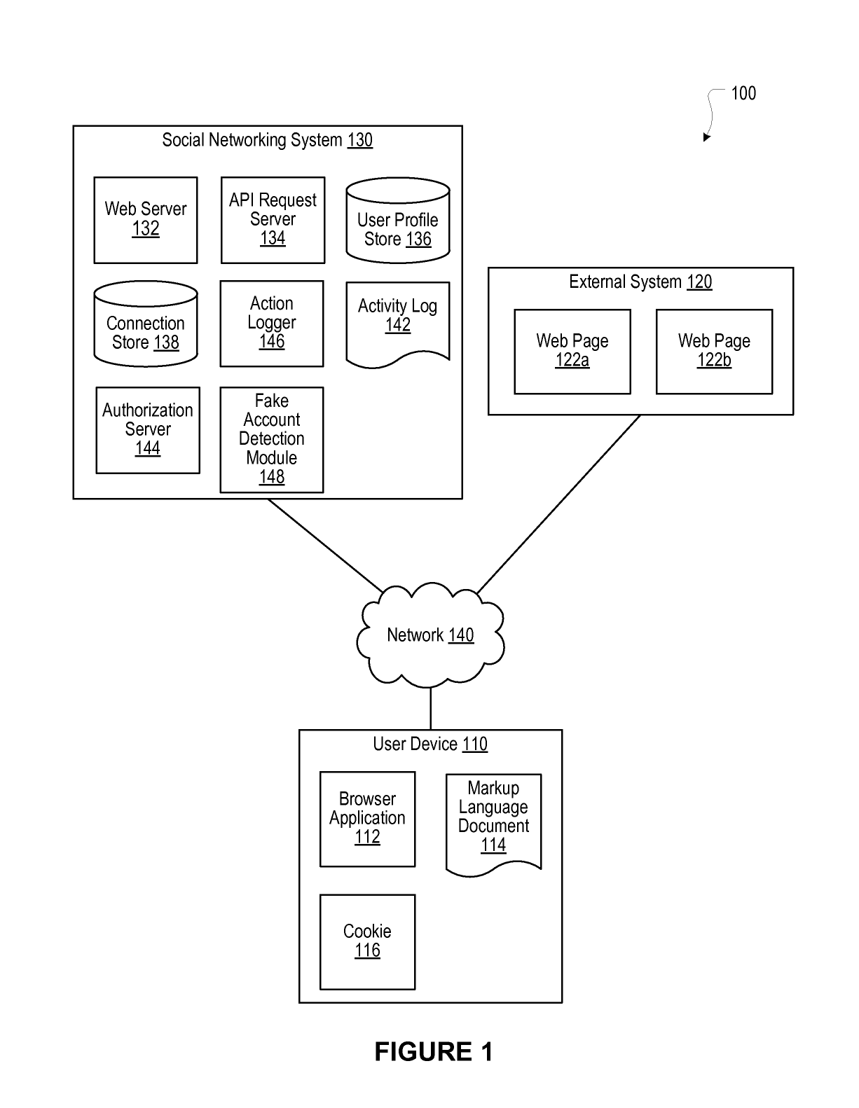

FIG. 1 is a network diagram of a system 100 for detecting fake accounts in a social networking system 130 in accordance with an embodiment of the invention. The system 100 includes one or more user devices 110, one or more external systems 120, the social networking system 130, and a network 140. For purposes of illustration, the embodiment of the system 100, shown by FIG. 1, includes a single external system 120 and a single user device 110. However, in other embodiments, the system 100 may include more user devices 110 and/or more external systems 120. In certain embodiments, the social networking system 130 is operated by a social network provider, whereas the external systems 120 are separate from the social networking system 130 in that they may be operated by different entities. In various embodiments, however, the social networking system 130 and the external systems 120 operate in conjunction to provide social networking services to users (or members) of the social networking system 130. In this sense, the social networking system 130 provides a platform or backbone, which other systems, such as external systems 120, may use to provide social networking services and functionalities to users across the Internet.

The user device 110 comprises one or more computing devices that can receive input from a user and transmit and receive data via the network 140. In one embodiment, the user device 110 is a conventional computer system executing, for example, a Microsoft Windows compatible operating system (OS), Apple OS X, and/or a Linux distribution. In another embodiment, the user device 110 can be a device having computer functionality, such as a smart-phone, a tablet, a personal digital assistant (PDA), a mobile telephone, etc. The user device 110 is configured to communicate via the network 140. The user device 110 can execute an application, for example, a browser application that allows a user of the user device 110 to interact with the social networking system 130. In another embodiment, the user device 110 interacts with the social networking system 130 through an application programming interface (API) provided by the native operating system of the user device 110, such as iOS and ANDROID. The user device 110 is configured to communicate with the external system 120 and the social networking system 130 via the network 140, which may comprise any combination of local area and/or wide area networks, using wired and/or wireless communication systems.

In one embodiment, the network 140 uses standard communications technologies and protocols. Thus, the network 140 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 140 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 140 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 110 may display content from the external system 120 and/or from the social networking system 130 by processing a markup language document 114 received from the external system 120 and from the social networking system 130 using a browser application 112. The markup language document 114 identifies content and one or more instructions describing formatting or presentation of the content. By executing the instructions included in the markup language document 114, the browser application 112 displays the identified content using the format or presentation described by the markup language document 114. For example, the markup language document 114 includes instructions for generating and displaying a web page having multiple frames that include text and/or image data retrieved from the external system 120 and the social networking system 130. In various embodiments, the markup language document 114 comprises a data file including extensible markup language (XML) data, extensible hypertext markup language (XHTML) data, or other markup language data. Additionally, the markup language document 114 may include JavaScript Object Notation (JSON) data, JSON with padding (JSONP), and JavaScript data to facilitate data-interchange between the external system 120 and the user device 110. The browser application 112 on the user device 110 may use a JavaScript compiler to decode the markup language document 114.

The markup language document 114 may also include, or link to, applications or application frameworks such as FLASH™ or Unity™ applications, the SilverLight™ application framework, etc.

In one embodiment, the user device 110 also includes one or more cookies 116 including data indicating whether a user of the user device 110 is logged into the social networking system 130, which may enable customization of the data communicated from the social networking system 130 to the user device 110.

The external system 120 includes one or more web servers that include one or more web pages 122a, 122b, which are communicated to the user device 110 using the network 140. The external system 120 is separate from the social networking system 130. For example, the external system 120 is associated with a first domain, while the social networking system 130 is associated with a separate social networking domain. Web pages 122a, 122b, included in the external system 120, comprise markup language documents 114 identifying content and including instructions specifying formatting or presentation of the identified content.

The social networking system 130 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure.

Users may join the social networking system 130 and then add connections to any number of other users of the social networking system 130 to whom they desire to be connected. As used herein, the term “friend” refers to any other user of the social networking system 130 to whom a user has formed a connection, association, or relationship via the social networking system 130. For example, in an embodiment, if users in the social networking system 130 are represented as nodes in the social graph, the term “friend” can refer to an edge formed between and directly connecting two user nodes.

Connections may be added explicitly by a user or may be automatically created by the social networking system 130 based on common characteristics of the users (e.g., users who are alumni of the same educational institution). For example, a first user specifically selects a particular other user to be a friend. Connections in the social networking system 130 are usually in both directions, but need not be, so the terms “user” and “friend” depend on the frame of reference. Connections between users of the social networking system 130 are usually bilateral (“two-way”), or “mutual,” but connections may also be unilateral, or “one-way.” For example, if Bob and Joe are both users of the social networking system 130 and connected to each other, Bob and Joe are each other's connections. If, on the other hand, Bob wishes to connect to Joe to view data communicated to the social networking system 130 by Joe, but Joe does not wish to form a mutual connection, a unilateral connection may be established. The connection between users may be a direct connection; however, some embodiments of the social networking system 130 allow the connection to be indirect via one or more levels of connections or degrees of separation.

In addition to establishing and maintaining connections between users and allowing interactions between users, the social networking system 130 provides users with the ability to take actions on various types of items supported by the social networking system 130. These items may include groups or networks (i.e., social networks of people, entities, and concepts) to which users of the social networking system 130 may belong, events or calendar entries in which a user might be interested, computer-based applications that a user may use via the social networking system 130, transactions that allow users to buy or sell items via services provided by or through the social networking system 130, and interactions with advertisements that a user may perform on or off the social networking system 130. These are just a few examples of the items upon which a user may act on the social networking system 130, and many others are possible. A user may interact with anything that is capable of being represented in the social networking system 130 or in the external system 120, separate from the social networking system 130, or coupled to the social networking system 130 via the network 140.

The social networking system 130 is also capable of linking a variety of entities. For example, the social networking system 130 enables users to interact with each other as well as external systems 120 or other entities through an API, a web service, or other communication channels. The social networking system 130 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 130. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 130 modifies edges connecting the various nodes to reflect the relationships and interactions.

The social networking system 130 also includes user-generated content, which enhances a user's interactions with the social networking system 130. User-generated content may include anything a user can add, upload, send, or “post” to the social networking system 130. For example, a user communicates posts to the social networking system 130 from a user device 110. Posts may include data such as status updates or other textual data, location information, images such as photos, videos, links, music or other similar data and/or media. Content may also be added to the social networking system 130 by a third-party. Content “items” are represented as objects in the social networking system 130. In this way, users of the social networking system 130 are encouraged to communicate with each other by posting text and content items of various types of media through various communication channels. Such communication increases the interaction of users with each other and increases the frequency with which users interact with the social networking system 130.

The social networking system 130 includes a web server 132, an API request server 134, a user profile store 136, a connection store 138, an action logger 146, an activity log 142, an authorization server 144, and a fake account detection module 148. In an embodiment of the invention, the social networking system 130 may include additional, fewer, or different components for various applications. Other components, such as network interfaces, security mechanisms, load balancers, failover servers, management and network operations consoles, and the like are not shown so as to not obscure the details of the system.

The user profile store 136 maintains information about user accounts, including biographic, demographic, and other types of descriptive information, such as work experience, educational history, hobbies or preferences, location, and the like that has been declared by users or inferred by the social networking system 130. This information is stored in the user profile store 136 such that each user is uniquely identified. The social networking system 130 also stores data describing one or more connections between different users in the connection store 138. The connection information may indicate users who have similar or common work experience, group memberships, hobbies, or educational history. Additionally, the social networking system 130 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 130, such as non-person entities, buckets, cluster centers, images, interests, pages, external systems, concepts, and the like are also stored in the connection store 138.

The social networking system 130 maintains data about objects with which a user may interact. To maintain this data, the user profile store 136 and the connection store 138 store instances of the corresponding type of objects maintained by the social networking system 130. Each object type has information fields that are suitable for storing information appropriate to the type of object. For example, the user profile store 136 contains data structures with fields suitable for describing a user's account and information related to a user's account. When a new object of a particular type is created, the social networking system 130 initializes a new data structure of the corresponding type, assigns a unique object identifier to it, and begins to add data to the object as needed. This might occur, for example, when a user becomes a user of the social networking system 130, the social networking system 130 generates a new instance of a user profile in the user profile store 136, assigns a unique identifier to the user account, and begins to populate the fields of the user account with information provided by the user.

The connection store 138 includes data structures suitable for describing a user's connections to other users, connections to external systems 120 or connections to other entities. The connection store 138 may also associate a connection type with a user's connections, which may be used in conjunction with the user's privacy setting to regulate access to information about the user. In an embodiment of the invention, the user profile store 136 and the connection store 138 may be implemented as a federated database.

Data stored in the connection store 138, the user profile store 136, and the activity log 142 enables the social networking system 130 to generate the social graph that uses nodes to identify various objects and edges connecting nodes to identify relationships between different objects. For example, if a first user establishes a connection with a second user in the social networking system 130, user accounts of the first user and the second user from the user profile store 136 may act as nodes in the social graph. The connection between the first user and the second user stored by the connection store 138 is an edge between the nodes associated with the first user and the second user. Continuing this example, the second user may then send the first user a message within the social networking system 130. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 130 (or, alternatively, in an image maintained by another system outside of the social networking system 130). The image may itself be represented as a node in the social networking system 130. This tagging action may create edges between the first user and the second user as well as create an edge between each of the users and the image, which is also a node in the social graph. In yet another example, if a user confirms attending an event, the user and the event are nodes obtained from the user profile store 136, where the attendance of the event is an edge between the nodes that may be retrieved from the activity log 142. By generating and maintaining the social graph, the social networking system 130 includes data describing many different types of objects and the interactions and connections among those objects, providing a rich source of socially relevant information.

The web server 132 links the social networking system 130 to one or more user devices 110 and/or one or more external systems 120 via the network 140. The web server 132 serves web pages, as well as other web-related content, such as Java, JavaScript, Flash, XML, and so forth. The web server 132 may include a mail server or other messaging functionality for receiving and routing messages between the social networking system 130 and one or more user devices 110. The messages can be instant messages, queued messages (e.g., email), text and SMS messages, or any other suitable messaging format.

The API request server 134 allows one or more external systems 120 and user devices 110 to call access information from the social networking system 130 by calling one or more API functions. The API request server 134 may also allow external systems 120 to send information to the social networking system 130 by calling APIs. The external system 120, in one embodiment, sends an API request to the social networking system 130 via the network 140, and the API request server 134 receives the API request. The API request server 134 processes the request by calling an API associated with the API request to generate an appropriate response, which the API request server 134 communicates to the external system 120 via the network 140. For example, responsive to an API request, the API request server 134 collects data associated with a user, such as the user's connections that have logged into the external system 120, and communicates the collected data to the external system 120. In another embodiment, the user device 110 communicates with the social networking system 130 via APIs in the same manner as external systems 120.

The action logger 146 is capable of receiving communications from the web server 132 about user actions on and/or off the social networking system 130. The action logger 146 populates the activity log 142 with information about user actions, enabling the social networking system 130 to discover various actions taken by its users within the social networking system 130 and outside of the social networking system 130. Any action that a particular user takes with respect to another node on the social networking system 130 may be associated with each user's account, through information maintained in the activity log 142 or in a similar database or other data repository. Examples of actions taken by a user within the social networking system 130 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 130, the action is recorded in the activity log 142. In one embodiment, the social networking system 130 maintains the activity log 142 as a database of entries. When an action is taken within the social networking system 130, an entry for the action is added to the activity log 142. The activity log 142 may be referred to as an action log.

Additionally, user actions may be associated with concepts and actions that occur within an entity outside of the social networking system 130, such as an external system 120 that is separate from the social networking system 130. For example, the action logger 146 may receive data describing a user's interaction with an external system 120 from the web server 132. In this example, the external system 120 reports a user's interaction according to structured actions and objects in the social graph.

Other examples of actions where a user interacts with an external system 120 include a user expressing an interest in an external system 120 or another entity, a user posting a comment to the social networking system 130 that discusses an external system 120 or a web page 122a within the external system 120, a user posting to the social networking system 130 a Uniform Resource Locator (URL) or other identifier associated with an external system 120, a user attending an event associated with an external system 120, or any other action by a user that is related to an external system 120. Thus, the activity log 142 may include actions describing interactions between a user of the social networking system 130 and an external system 120 that is separate from the social networking system 130.

The authorization server 144 enforces one or more privacy settings of the users of the social networking system 130. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 120, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 120. One embodiment allows the specification of the set of entities to comprise an enumeration of entities. For example, the user may provide a list of external systems 120 that are allowed to access certain information. Another embodiment allows the specification to comprise a set of entities along with exceptions that are not allowed to access the information. For example, a user may allow all external systems 120 to access the user's work information, but specify a list of external systems 120 that are not allowed to access the work information. Certain embodiments call the list of exceptions that are not allowed to access certain information a “block list”. External systems 120 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 144 contains logic to determine if certain information associated with a user can be accessed by a user's friends, external systems 120, and/or other applications and entities. The external system 120 may need authorization from the authorization server 144 to access the user's more private and sensitive information, such as the user's work phone number. Based on the user's privacy settings, the authorization server 144 determines if another user, the external system 120, an application, or another entity is allowed to access information associated with the user, including information about actions taken by the user.

The fake account detection module 148 contains logic to detect fake accounts in the social networking system 130. Accounts associated with a resource employed in the creation or management of accounts may be identified as potentially fake. Selected features associated with the accounts may be used to define a k-dimensional space. The accounts of the social networking system 130 associated with the scare resource may be plotted in the k-dimensional space to form a cluster. When a radius of the cluster is within a predetermined threshold, the accounts may be identified as fake accounts, as described in more detail below.

### Fake Account Detection

Fake accounts may be defined or characterized in various ways. For example, a fake account may simply refer to an account that has been determined not to satisfy a definition or criterion for a genuine account. As another example, a fake account also may be any account that was created in violation of the policies that regulate use of the social networking system 130. Notwithstanding a particular definition for them, the identification of fake accounts in the social networking system 130 is important to maintain the intended operation and integrity of the social networking system 130.

Fake accounts may be created by illegitimate entities (e.g., hackers, attackers, spammers, etc.) that seek only to, for example, spam legitimate users with uninvited, irrelevant, or otherwise inappropriate content. An illegitimate entity associated with a fake account may attempt to connect with other users of the social networking system 130 to expand the network of the entity and thus create a greater number of recipients for its inappropriate content. A connection established between the illegitimate entity and the user would potentially improperly subject the user to undesirable content. Further, attempts by the illegitimate entity associated with a fake account to entice users into taking action that the users otherwise would not take may rely on false or misleading statements. The proliferation of false and misleading statements by the illegitimate entity to deceive innocent users detracts from the foundation of candid, genuine, and open communication that serves as a hallmark of the social networking system 130.

In an embodiment of the invention, resources utilized or involved in the creation of accounts with the social networking system 130 may be used to identify fake accounts. When features of accounts associated with a resource are similar, the accounts may be identified as fake, as discussed in more detail below. The resources may be used by the illegitimate entities to create hundreds or even thousands of fake accounts. To economize in the creation of large numbers of fake accounts, the resources, especially scarce resources, may be sparingly used by the illegitimate entities. One example of a resource used by illegitimate entities is an IP address. Because an IP address is relatively difficult and expensive to obtain or change, an illegitimate entity may choose to create fake accounts with only one IP address or a small number of IP addresses.

Other resources may be used to identify fake accounts. For example, a user agent may be considered a scarce resource for attackers that use a particular browser. Similarity among accounts associated with a user agent may inform whether the accounts are fake. As another example, a web page of the social networking system 130 also may be considered a scarce resource because the development of the web page, or the modification of the web page, may require significant time and effort from the illegitimate entity. Similarity among accounts that “like” the web page may inform whether the accounts are fake. As yet another example, a particular account, in view of its friends or other connections, may be considered a scarce resource because the illegitimate entity may have to invest considerable time and effort to establish and change the particular account and its connections in the social networking system 130. Similarity among accounts connected to the particular account may inform whether the accounts are fake.

In an embodiment of the invention, any suitable resource or resources, which may be involved in or related to the creation of accounts, may be used to assist in the determination of fake accounts. Further, in an embodiment of the invention, a suitable resource may include a scarce resource that may be relatively difficult or costly for an illegitimate entity to obtain, maintain, modify, replace, or otherwise manage.

Based on one or a plurality of resources, characteristics, attributes, or any other features of accounts in the social networking system 130 associated with the resources may be selected to determine which of the accounts are fake. The features used to identify fake accounts may relate to activities, users, or any other dimension of the social networking system 130. An example dimension to which features may relate is the process of registering an account with the social networking system 130. Features of the account registration process may include, for example: the number or identity of persons imported from an email account of a user and proposed by the social networking system 130 as potential connections for the user; the time elapsed during the registration process; the age of a cookie associated with the user; the age of the internet domain from which the user registers; etc. Another example dimension to which features may relate is demographics of users of the social networking system 130. Features of user demographics may include, for example: the age of the user; the gender of the user; ethnicity of the user; the religious beliefs of the user; the political affiliations of the user; the employment history of the user; the income level of the user; etc. In an embodiment of the invention, any suitable features relating to the above-mentioned or other dimensions may be utilized in the determination of fake accounts.

To identify similarity among accounts, the accounts may be analyzed and compared based on their feature values. Fake accounts are often similar because the circumstances surrounding their creation may be similar. For example, because one illegitimate entity may be responsible for the creation of many fake accounts, the created accounts may all share or reflect characteristics of the illegitimate entity or the resources used by the illegitimate entity to create the accounts. When accounts are sufficiently similar based on their feature values, the accounts may be considered fake.

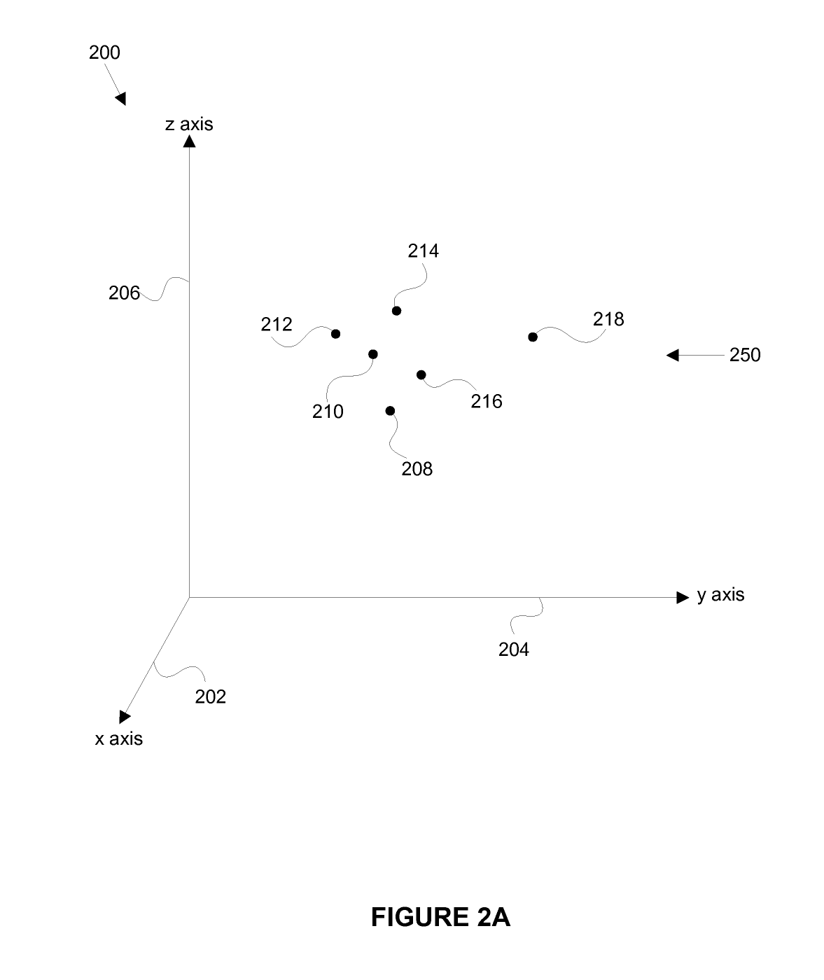

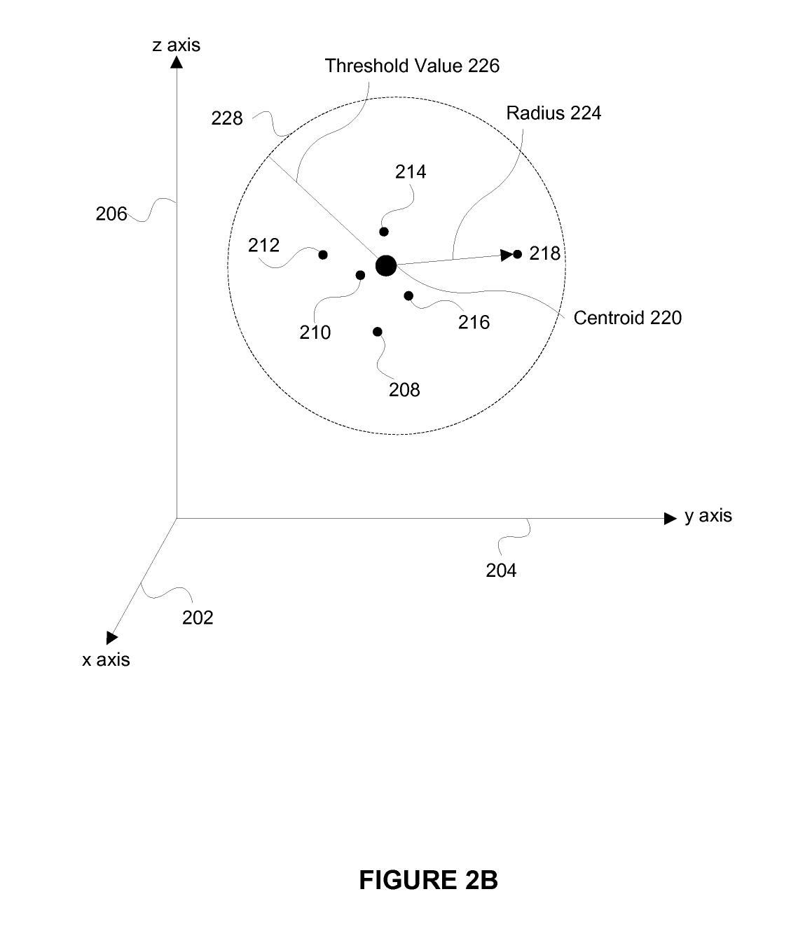

FIG. 2A illustrates a graphical mapping 200 of accounts associated with a resource in accordance with an embodiment of the invention. For purposes of illustration, the mapping 200 is shown as a three dimensional space having an x axis 202, a y axis 204, and a z axis 206 with each axis corresponding to a feature of the accounts. In an embodiment of the invention, any number of features can be identified for the accounts and mapped to a k-dimensional space, where k may be any value such as an integer value. The accounts may be associated with various features to which numerical values may be assigned. The mapping 200 includes points 208, 210, 212, 214, 216, 218 that represent accounts associated with the resource and mapped according to their feature values. Each of the points 208, 210, 212, 214, 216, 218 is a graphical representation of an account. The points 208, 210, 212, 214, 216, 218 together represent a cluster 250 of accounts based on the resource. While six accounts are shown as the points 208, 210, 212, 214, 216, 218, any number of accounts may be represented in the cluster 250.

To determine whether the accounts are fake, the social networking system 130 may determine the magnitude of the cluster 250. A tight, or close, clustering of the points 208, 210, 212, 214, 216, 218 represents relatively similar accounts, while a loose, or far, clustering of the points 208, 210, 212, 214, 216, 218 represents relatively dissimilar accounts. When the cluster 250 is found to be less than a predetermined size, the accounts may be deemed sufficiently similar to constitute fake accounts.

FIG. 2B includes a centroid 220 for the points 208, 210, 212, 214, 216, 218 to determine the extent, or magnitude, of the cluster 250 in accordance with an embodiment of the invention. The centroid 220 may be calculated and determined by the social networking system 130 according to any conventional technique. A radius 224 indicative of the extent of the cluster 250 is determined that connects the centroid 220 of the cluster and the furthest point from the centroid 220. In an embodiment of the invention, to determine the furthest point from the centroid 220, the social networking system 130 may calculate the distance between the centroid 220 and each of the points 208, 210, 212, 214, 216, 218. The calculated distance may be any distance, such as a Euclidian distance, a Manhattan distance, etc. The point associated with the largest calculated distance may be determined to be the furthest point. Once the furthest point is identified, the radius 224 can be drawn from the centroid 220 to the furthest point. As shown, the radius 224 extends from the centroid 220 to the point 218, which is the further point. In an embodiment of the invention, the extent of the cluster 250 may be determined in any other suitable manner.

A threshold value 226 is graphically illustrated as a sphere 228 having a center at the centroid 220. If the radius 224 is less than the threshold value 226, the accounts corresponding to the points 208, 210, 212, 214, 216, 218 may be deemed sufficiently similar and thus fake. If the radius 224 is equal to or greater than the threshold value 226, the accounts corresponding to the points 208, 210, 212, 214, 216, 218 may be not be deemed sufficiently similar to be fake. As shown, the radius 224 is less than the threshold value 226. Accordingly, the social networking system 130 may determine that the accounts corresponding to the points 208, 210, 212, 214, 216, 218 are fake.

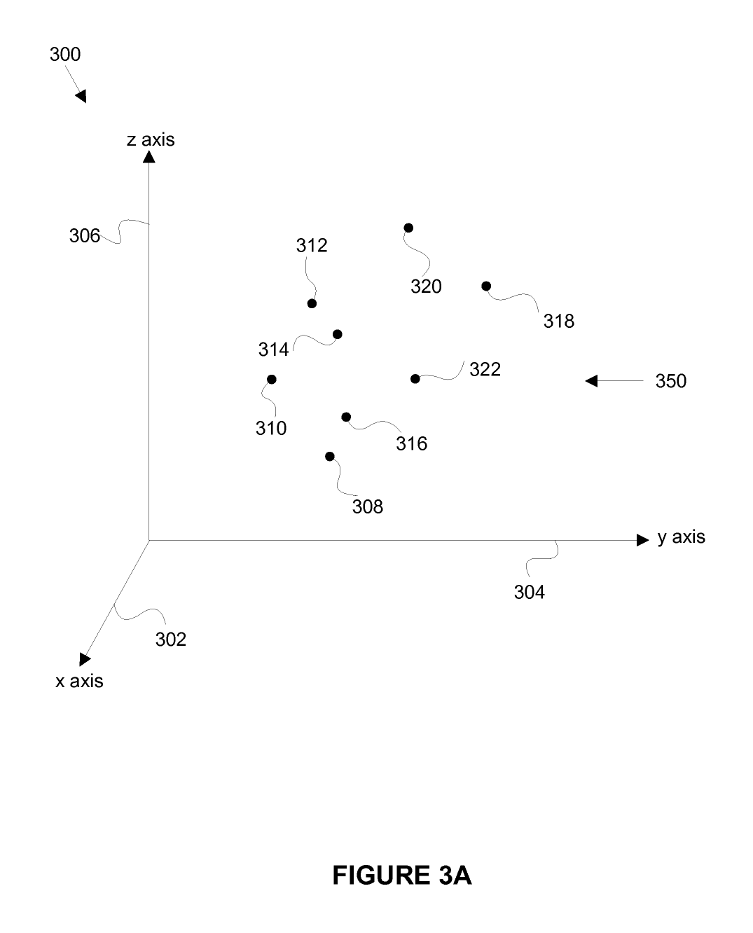

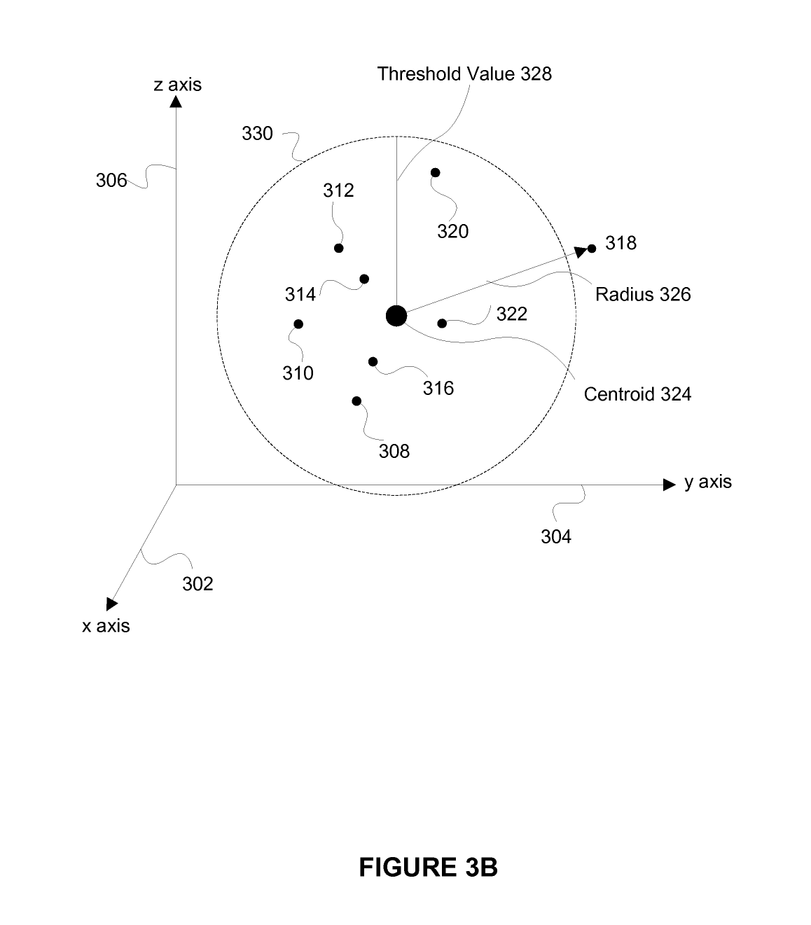

FIG. 3A illustrates a graphical mapping 300 of accounts associated with a resource in accordance with an embodiment of the invention. For purposes of illustration, like the mapping 200, the mapping 300 is shown as a three dimensional space having an x axis 302, a y axis 304, and a z axis 306 with each axis corresponding to a feature of the accounts. In an embodiment of the invention, any number of features can be identified for the accounts and mapped to a k-dimensional space, where k may be any value including an integer value. The accounts may be associated with various features to which numerical values may be assigned. The mapping 300 includes points 308, 310, 312, 314, 316, 318, 320, 322 that represent accounts mapped according to their feature values. Each of the points 308, 310, 312, 314, 316, 318, 320, 322 is a graphical representation of an account. The points 308, 310, 312, 314, 316, 318, 320, 322 together represent a cluster 350 of accounts based on the resource. While eight accounts are shown as the points 308, 310, 312, 314, 316, 318, 320, 322, any number of accounts may be represented in the cluster 350.

To determine whether the accounts are fake, the social networking system 130 may determine the magnitude of the cluster 350. A tight clustering of the points 308, 310, 312, 314, 316, 318, 320, 322 represents relatively similar accounts, while a loose clustering of the points 308, 310, 312, 314, 316, 318, 320, 322 represents relatively dissimilar accounts. When the cluster 350 is found to be less than a predetermined size, the accounts may be deemed sufficiently similar to constitute fake accounts.

FIG. 3B includes a centroid 324 for the points 308, 310, 312, 314, 316, 318, 320, 322 to determine the extent of the cluster 350 in accordance with an embodiment of the invention. The centroid 324 may be calculated and determined by the social networking system 130 according to any conventional technique. A radius 326 indicative of the extent of the cluster 350 connects the centroid 324 of the cluster and the furthest point from the centroid 324. In an embodiment of the invention, to determine the furthest point from the centroid 324, the social networking system 130 may calculate the distance between the centroid 324 and each of the points 308, 310, 312, 314, 316, 318, 320, 322. The calculated distance may be any distance, such as a Euclidian distance, a Manhattan distance, etc. The point associated with the largest calculated distance may be determined to be the furthest point. Once the furthest point is identified, the radius 326 can be drawn from the centroid 324 to the furthest point. As shown, the radius 326 extends from the centroid 324 to the point 318, which is the furthest point. In an embodiment of the invention, the extent of the cluster 350 may be determined in any other suitable manner.

A threshold value 328 is graphically illustrated as a sphere 330 having a center at the centroid 324. If the radius 326 is less than the threshold value 328, the accounts corresponding to the points 308, 310, 312, 314, 316, 318, 320, 322 may be deemed sufficiently similar and thus fake. If the radius 326 is equal to or greater than the threshold value 328, the accounts corresponding to the points 308, 310, 312, 314, 316, 318, 320, 322 may not be determined to be fake. As shown, the radius 326 is greater than the threshold value 328. Accordingly, the social networking system 130 may not determine that the accounts corresponding to the points 308, 310, 312, 314, 316, 318, 320, 322 are fake. In an embodiment of the invention, when the radius 326 is equal to or greater than the threshold value 328, the social networking system 130 may determine that the accounts corresponding to the points 308, 310, 312, 314, 316, 318, 320, 322 are not fake.

As shown, the cluster 350 represented by the points 308, 310, 312, 314, 316, 318, 320, 322 is different from the cluster 250 represented by the points 208, 210, 212, 214, 216, 218. The accounts of the cluster 250 may be in whole or in part different from the accounts of the cluster 350. In an embodiment of the invention, in general, the accounts representing a first cluster in a first mapping to identify fake accounts may be different from the accounts representing a second cluster in a second mapping to identify fake accounts.

Further, in an embodiment of the invention, the features of the accounts underlying the mapping 200 may be in whole or in part different from the features of the accounts underlying the mapping 300. For example, the mapping 200 may involve features, such as the time elapsed during the registration process, the age of a cookie associated with the user, and the age of the internet domain from which the user registers. In contrast, the mapping 300 may involve features, such as the age of the user and the gender of the user. In this example, the features underlying two mappings are entirely different. As another example, a first mapping to determine fake accounts and a second mapping to determine fake accounts may involve common features.

As discussed above, the determination of fake accounts may involve the association of accounts with one or more resources. For example, the accounts of the cluster 350 may be associated with one resource while the accounts of the cluster 250 could be associated with another resource. As another example, the mapping 200 of the accounts in the cluster 250 may be based on one associated resource, such as an IP address. The mapping 300 of the accounts in the cluster 350 may be based on other associated resources, such as an IP address and a particular account to which possibly fake accounts are associated. In an embodiment of the invention, each such determination of fake accounts may involve common or different resources. Further, a determination of fake accounts may involve accounts associated with more than one resource.

In an embodiment of the invention, the threshold value (i.e., the threshold value 226 and the threshold value 328) may be any suitable value. The threshold value may be selected based on the desired degree of actual similarity among the accounts before the accounts are deemed to be similar. For example, in contexts where the accounts should be deemed to be similar only when there is a relatively high likelihood of possible actual similarity, the threshold value may be set to a relatively small value. As another example, in contexts where the accounts may be deemed to be similar when there is only a modest likelihood of possible actual similarity, the threshold value may be set to a relatively large value. As yet another example, in contexts where it is especially important not to mistakenly identify accounts as fake, the threshold value may be set to a relatively small value to optimize the likelihood that the accounts are fake. In an embodiment of the invention, a threshold value for one mapping of accounts may be different from a threshold value for another mapping of accounts. Further, the threshold value may be based on the resource, or the type of resource, to which the accounts are associated. Thus, the threshold value may be configurable and may be programmed by an administrator of the social networking system 130 to have any value appropriate for a given context of the social networking system 130.

In an embodiment, the determination of the extent of a cluster may be based on less than the total number of accounts associated with the cluster. For example, a predetermined number or percentage of the accounts in a cluster may be considered in the determination of the extent of the cluster, and the remainder of the accounts therein not considered. As another example, in a mapping of accounts associated with a cluster, certain of the accounts mapped to outer regions of the cluster (i.e., outliers) may be discarded. In this regard, a centroid of the cluster may be determined based on all of the accounts. Certain accounts that, for example, fall outside a predetermined absolute or percentage distance from the centroid may be discarded in determining the radius of the cluster. In this manner, the determination of the extent of a cluster may account for possible skew caused by extreme feature values of certain accounts.

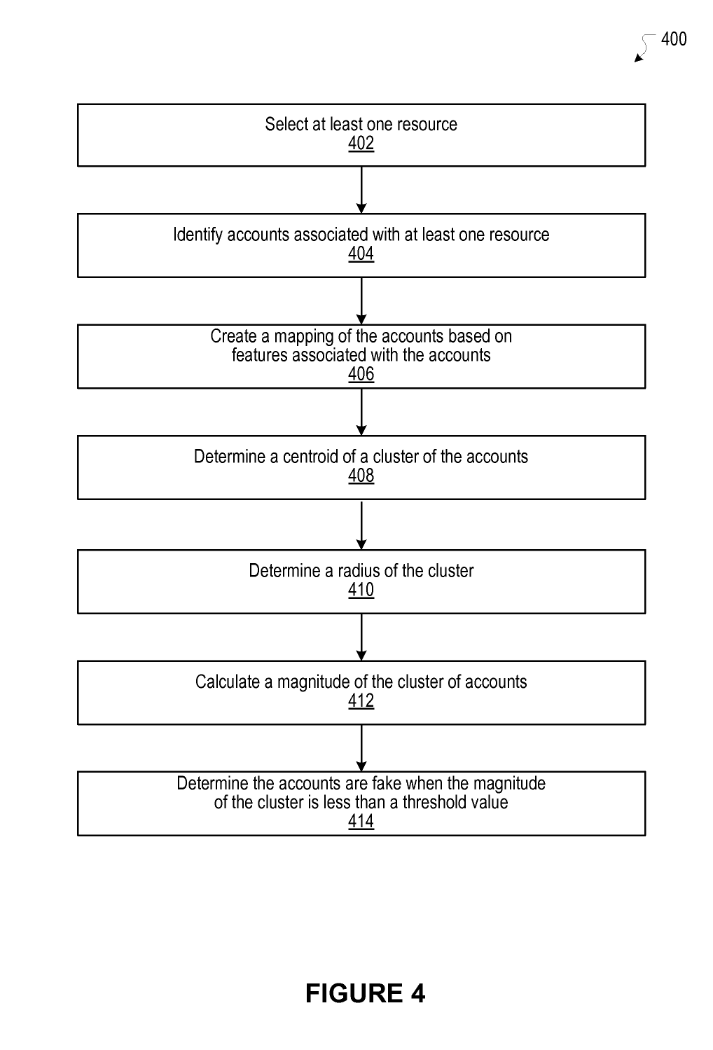

FIG. 4 illustrates a process 400 for determining fake accounts in accordance with an embodiment of the invention. At block 402, at least one resource is selected. The resource may be any suitable resource, including a scarce resource. At block 404, accounts associated with the at least one resource are identified. At block 406, a mapping of the accounts is created based on features associated with the accounts. At block 408, a centroid of a cluster of the accounts is determined. At block 410, a radius of the cluster is determined. At block 412, a magnitude of the cluster of accounts is calculated. At block 414, the accounts are determined to be fake when the magnitude of the cluster is less than a threshold value.

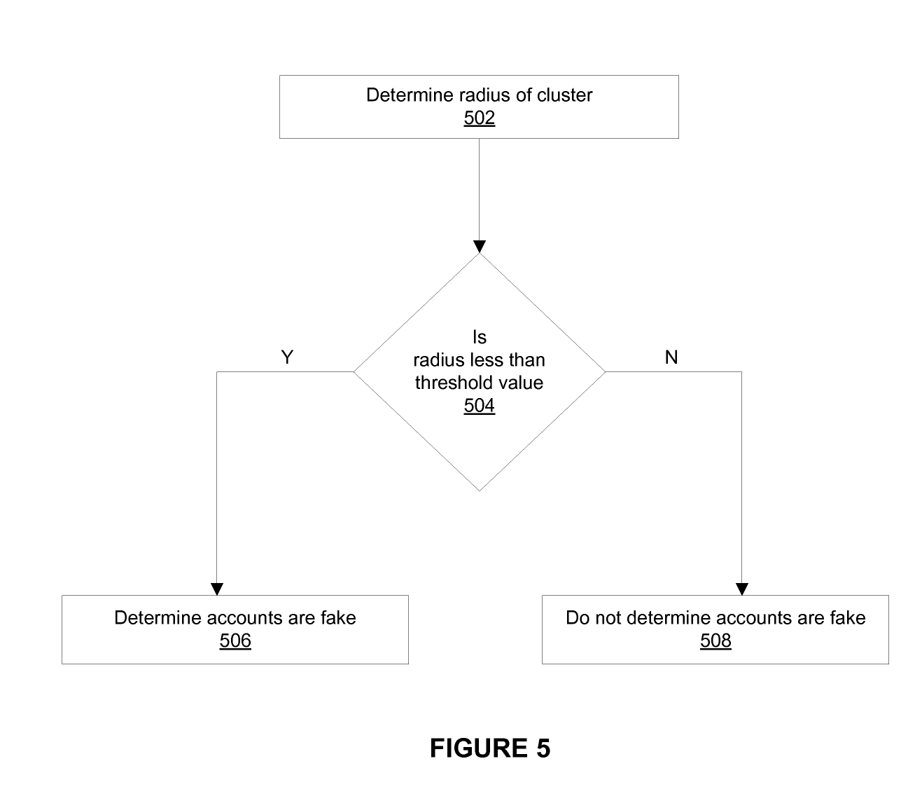

FIG. 5 illustrates a process 500 for comparing a radius of a centroid with a threshold value in accordance with an embodiment of the invention. At block 502, a radius of a cluster of accounts is determined 502. The cluster may be a mapping of accounts based feature values of the accounts. The accounts may be associated with a resource. The radius of the cluster may be determined by any suitable techniques. At decision block 504, it is determined whether the radius of the cluster is less than a threshold value. The threshold value may be determined by an operator of the social networking system 130 based on a preferred or required accuracy in identifying fake accounts. If the result of the decision block 504 is yes, then the accounts are determined to be fake in block 506. The accounts determined to be fake may then be challenged, deactivated, reported, or subject to any other suitable action. If the result of decision block 504 is no, then the accounts are not determined to be fake. In an embodiment of the invention, these accounts may be subject to other or later efforts to identify the accounts as possibly fake.

In an embodiment of the invention, the process 400 and the process 500 may be performed in whole or in part by the fake account detection module 148 or the social networking system 130.

### Conclusion

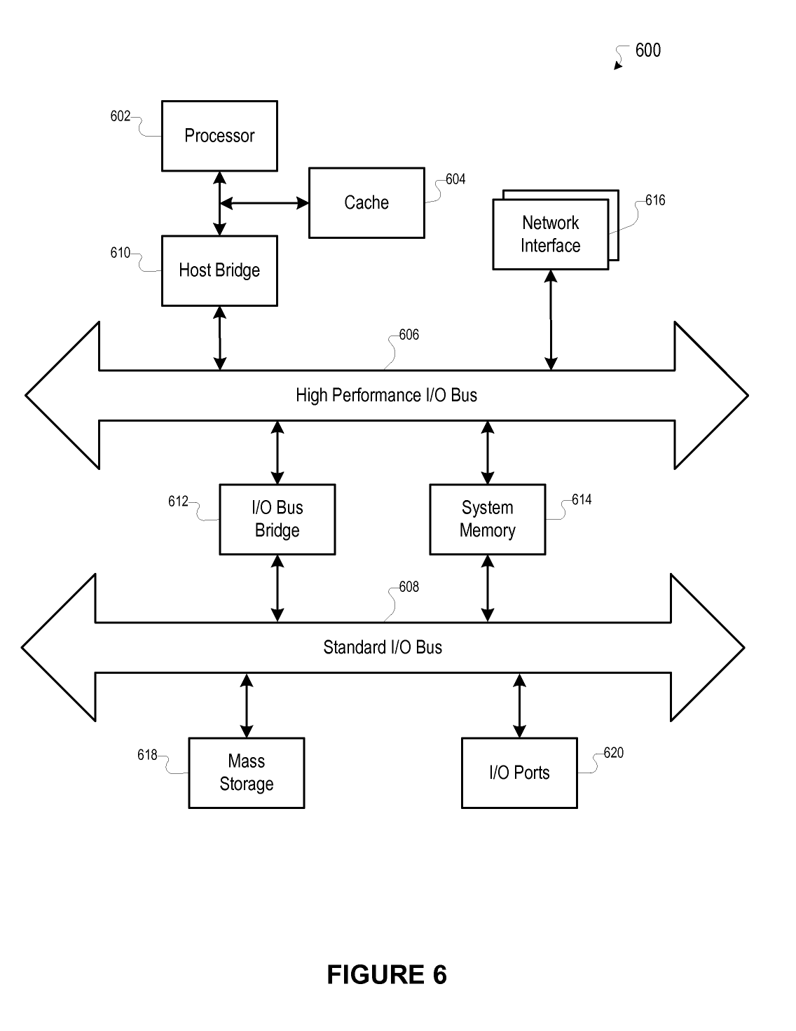

The foregoing processes and features can be implemented by a wide variety of machine and computer system architectures and in a wide variety of network and computing environments. FIG. 6 illustrates an example of a computer system 600 that may be used to implement one or more of the computing devices identified above. The computer system 600 includes sets of instructions for causing the computer system 600 to perform the processes and features discussed herein. The computer system 600 may be connected (e.g., networked) to other machines. In a networked deployment, the computer system 600 may operate in the capacity of a server machine or a client machine in a client-server network environment, or as a peer machine in a peer-to-peer (or distributed) network environment. In an embodiment of the invention, the computer system 600 may be the social networking system 130, the user device 110, the external system 120, or a component thereof. In an embodiment of the invention, the computer system 600 may be one server among many that constitutes all or part of the social networking system 130.

The computer system 600 includes a processor 602, a cache memory 604, and one or more executable modules and drivers, stored on a computer-readable medium, directed to the processes and features described herein. Additionally, the computer system 600 includes a high performance input/output (I/O) bus 606 and a standard I/O bus 608. A host bridge 610 couples the processor 602 to the high performance I/O bus 606, whereas I/O bus bridge 612 couples the two buses 606 and 608 to each other. A system memory 614 and one or more network interfaces 616 couple to the bus 606. The computer system 600 may further include video memory and a display device coupled to the video memory (not shown). Mass storage 618 and I/O ports 620 couple to the bus 608. The computer system 600 may optionally include a keyboard and pointing device, a display device, or other input/output devices (not shown) coupled to the bus 608. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 600, including the input and output of data to and from software applications (not shown). The operating system provides an interface between the software applications being executed on the system and the hardware components of the system. Any suitable operating system may be used, such as the LINUX Operating System; the Apple Macintosh Operating System, available from Apple Computer Inc. of Cupertino, Calif.; UNIX operating systems; Microsoft® Windows® operating systems; BSD operating systems; and the like. Other implementations are possible.

The elements of the computer system 600 are described in greater detail below. In particular, the network interface 616 provides communication between the computer system 600 and any of a wide range of networks, such as an Ethernet (e.g., IEEE 802.3) network, a backplane, etc. The mass storage 618 provides permanent storage for the data and programming instructions to perform the above-described processes and features implemented by the respective computing systems identified above, whereas the system memory 614 (e.g., DRAM) provides temporary storage for the data and programming instructions when executed by the processor 602. The I/O ports 620 may be one or more serial and/or parallel communication ports that provide communication between additional peripheral devices, which may be coupled to the computer system 600.

The computer system 600 may include a variety of system architectures, and various components of the computer system 600 may be rearranged. For example, the cache 604 may be on-chip with processor 602. Alternatively, the cache 604 and the processor 602 may be packed together as a “processor module”, with processor 602 being referred to as the “processor core”. Furthermore, certain embodiments of the invention may neither require nor include all of the above components. For example, peripheral devices coupled to the standard I/O bus 608 may couple to the high performance I/O bus 606. In addition, in some embodiments, only a single bus may exist, with the components of the computer system 600 being coupled to the single bus. Furthermore, the computer system 600 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 600 which, when read and executed by one or more processors, cause the computer system 600 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 600, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 602. Initially, the series of instructions may be stored on a storage device, such as the mass storage 618. However, the series of instructions can be stored on any suitable computer readable storage medium. Furthermore, the series of instructions need not be stored locally, and could be received from a remote storage device, such as a server on a network, via the network interface 616. The instructions are copied from the storage device, such as the mass storage 618, into the system memory 614, and then accessed and executed by processor 602.

Examples of computer readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 600 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, or the like means that a particular feature, design, structure, or characteristic described in connection with the embodiment is included in at least one embodiment of the disclosure. The appearances of, for example, the phrase “in one embodiment”, “in an embodiment”, or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer implemented method comprising:
calculating, by a computer system, an extent of a cluster of accounts of a social networking system, wherein the calculating comprises:
aggregating, as the cluster of accounts, multiple accounts associated with a resource;
quantifying features of the multiple accounts as points across multiple dimensions, wherein at least two of the features correspond to different dimensions,
computing a centroid of the points;
computing a distance from the centroid to a farthest one of the points; and
identifying the computed distance as the extent; and
determining, by the computer system, that the accounts are fake when the extent of the cluster is less than a threshold value.

2. The method of claim 1, further comprising not determining the accounts are fake when the extent of the cluster is equal to or greater than the threshold value.

3. The method of claim 1, further comprising determining the accounts are fake when the extent of the clusters less than the threshold value.

4. The method of claim 1, further comprising selecting at least one resource.

5. The method of claim 4, wherein the at least one resource includes a scarce resource.

6. The method of claim 4, further comprising identifying the accounts associated with the at least one resource for mapping.

7. The method of claim 1, further comprising creating a mapping of the accounts based on features associated with the accounts.

8. The method of claim 7, wherein the mapping of the accounts is based on values of the features associated with the accounts.

9. The method of claim 8, wherein the features are associated with a dimension of the social networking system including at least one of activities and users.

10. The method of claim 1, further comprising determining a centroid of the cluster.

11. The method of claim 1, further comprising determining a furthest point representing an account from a centroid of the cluster.

12. The method of claim 11, wherein the determining a furthest point includes calculating a distance between the centroid and a point representing each of the accounts.

13. The method of claim 1, wherein the calculating includes determining a radius of the cluster.

14. The method of claim 13, further comprising comparing the radius with the threshold value.

15. The method of claim 14, further comprising determining the accounts are fake when the radius is less than the threshold value.

16. The method of claim 14, further comprising not determining the accounts are fake when the radius is equal to or greater than the threshold value.

17. The method of claim 14, further comprising determining the accounts are not fake when the radius is equal to or greater than the threshold value.

18. The method of claim 1, wherein the threshold value is programmable.

19. A computer-storage medium storing computer-executable instructions that, when executed, cause a computer system to perform a computer-implemented method comprising:
calculating a extent of a cluster of accounts of a social networking system, wherein the calculating comprises:
quantifying features of multiple accounts as points across multiple dimensions of a space, wherein at least two of the features correspond to different dimensions;
computing a distance from a centroid to a farthest one of the points; and
identifying the computed distance as the extent; and
determining the accounts are fake when the extent of the cluster is less than a threshold value.

20. A system comprising:
at least one processor; and
a memory storing instructions configured to instruct the at least one processor to perform:
calculating a magnitude of a duster of accounts of a social networking system; and
determining the accounts are fake when the magnitude of the cluster is less than a threshold value.
